(19) United States
(12) Patent Application Publication
(10) Pub. No.: US 2012/0156999 A1
(43) Pub. Date: Jun. 21, 2012

(54) WIRELESS COMMUNICATION SYSTEM

(75) Inventor: Tetsuya Kato, Minato-ku (JP)

(73) Assignee: NEC CORPORATION, Minato-ku, Tokyo (JP)

(21) Appl. No.: 13/391,185

(22) PCT Filed: Jun. 14, 2010
(86) PCT No.: PCT/JP2010/060031

§ 371 Date: Feb. 17, 2012

(30) Foreign Application Priority Data
Aug. 20, 2009 (JP) 2009-190800

(51) Int. Cl. H04B 15/00

(52) U.S. Cl. 455/63.1

(57) ABSTRACT

A wireless communication terminal measures the reception status of a downlink signal sent from a wireless base station according to a periodic ranging process, and notifies the measured reception status of the downlink signal to the wireless base station. The wireless base station measures the reception status of an uplink signal sent from the wireless communication terminal according to the periodic ranging process, and performs a control process for avoiding interference with a wireless signal between the wireless base station and the wireless communication terminal based on the measured reception status of the uplink signal and the measured reception status of the downlink signal which is notified from the wireless communication terminal.

### TECHNICAL FIELD

The present invention relates to a wireless communication system, a wireless base station, a wireless communication method, and a program for performing wireless communications.

### BACKGROUND ART

General wireless communication systems have an arrangement for removing an interference-induced error and resending a wireless signal with an error correcting function, a resending function, etc. when the wireless signal experiences interference. There is also a system for avoiding a situation in which interference is continuous by switching between frequencies to be used according to frequency hopping at all times in order to increase interference resistance.

There is disclosed a technology for storing an association between the subcarrier of a subchannel used for communications from a wireless base station to a wireless communication terminal and the positional information of the wireless communication terminal when a communication error occurs, and assigning a subchannel to be used by the wireless communication terminal based on the association (see, for example, Patent document 1).

### PRIOR TECHNICAL DOCUMENT

### Patent Document

Patent document 1: Japanese patent publication No. 2009-027625A

### SUMMARY OF THE INVENTION

### Problems to be Solved by the Invention

The above technology is problematic in that since interference cannot be avoided in real time, it is not possible to prevent a signal from being resent by avoiding the use of a frequency channel which is likely to cause an error from the outset, and efficient use of frequencies cannot be optimized.

It is an object of the present invention to provide a wireless communication system, a wireless base station, a wireless communication method, and a program which will solve the above problems.

### Means for Solving the Problems

According to the present invention, a wireless communication system includes a wireless base station and a wireless communication terminal, wherein

the wireless communication terminal measures the reception status of a downlink signal sent from the wireless base station according to a periodic ranging process, and notifies the measured reception status of the downlink signal to the wireless base station; and

the wireless base station measures the reception status of an uplink signal sent from the wireless communication terminal according to the periodic ranging process, and performs a control process for avoiding interference with a wireless signal between the wireless base station and the wireless communication terminal based on the measured reception status of the uplink signal and the measured reception status of the downlink signal which is notified from the wireless communication terminal.

According to the present invention, a wireless base station for performing wireless communications with a wireless communication terminal includes:

an interference monitoring section which measures the reception status of an uplink signal sent from the wireless communication terminal according to a periodic ranging process; and

an interference controller which performs a control process for avoiding interference with a wireless signal between the wireless base station and the wireless communication terminal based on the reception status of the uplink signal measured by the interference monitoring section and the reception status of the downlink signal in the periodic ranging process which is notified from the wireless communication terminal.

According to the present invention, a method of performing wireless communications between a wireless base station and a wireless communication terminal includes the steps of:

measuring the reception status of a downlink signal sent from the wireless base station to the wireless communication terminal according to a periodic ranging process;

measuring the reception status of an uplink signal sent from the wireless communication terminal to the wireless base station according to the periodic ranging process; and

performing a control process for avoiding interference with a wireless signal between the wireless base station and the wireless communication terminal based on the reception status of the uplink signal and the reception status of the downlink signal.

According to the present invention, a program for enabling a wireless base station that performs wireless communications with a wireless communication terminal to perform:

a sequence for measuring the reception status of an uplink signal sent from the wireless communication terminal according to a periodic ranging process; and

a sequence for performing a control process for avoiding an interference with a wireless signal between the wireless base station and the wireless communication terminal based on the measured reception status of the uplink signal and the reception status of a downlink signal in the periodic ranging process which is indicated from the wireless communication terminal.

### Advantages of the Invention

According to the present invention, as described above, it is possible to increase the efficient use of frequencies in an interference environment.

### BRIEF DESCRIPTION OF THE DRAWINGS

FIG. 1 is a diagram showing a wireless communication system according to an exemplary embodiment of the present invention;

FIG. 2 is a diagram showing an example of the layout of a plurality of wireless base stations covering respective adjacent cells;

FIG. 3 is a diagram showing an example of the internal configuration of a BS shown in FIG. 1;

FIG. 4 is a diagram showing an example of the internal configuration of an MS shown in FIG. 1;

FIG. 5 is a sequence diagram illustrative of a wireless communication method for general WiMAX; and

FIG. 6 is a sequence diagram illustrative of a wireless communication method according to the present exemplary embodiment.

### MODE FOR CARRYING OUT THE INVENTION

An exemplary embodiment of the present invention will be described below with reference to the drawings.

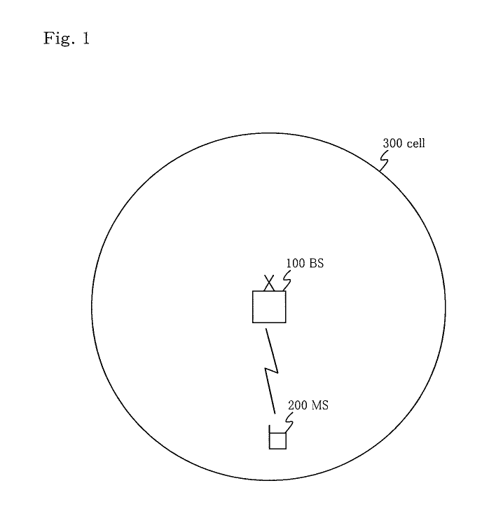

FIG. 1 is a diagram showing a wireless communication system according to an exemplary embodiment of the present invention. The wireless communication system according to the present invention will be described as being applied to WiMAX (Worldwide Interoperability for Microwave Access).

According to the present exemplary embodiment, the wireless communication system includes BS 100 and MS 200.

BS (Base Station) 100 is a wireless base station covering cell 300 serving as a communication range.

MS (Mobile Station) 200 is a movable wireless communication terminal. If MS 200 is present in cell 300, then MS 200 can perform wireless communications with BS 100.

The interference of wireless signals between a plurality of wireless base stations covering respective adjacent cells will be described below.

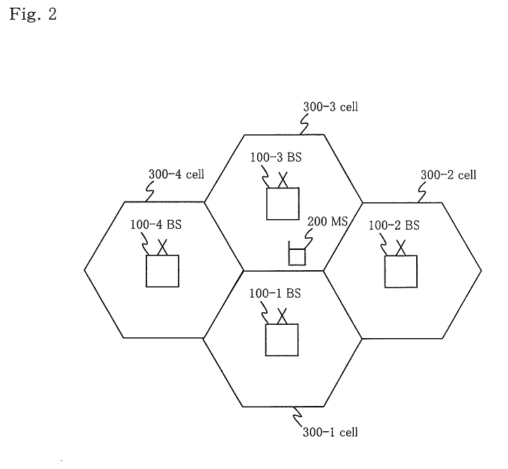

FIG. 2 is a diagram showing an example of the layout of a plurality of wireless base stations covering respective adjacent cells.

If BSs 100-1 through 100-4 as wireless base stations covering respective cells 300-1 through 300-4 are laid out as shown in FIG. 2, then there exists a communication event serving as an interference source for communication events between BSs 100-1 through 100-4 and MS 200 which moves therearound.

In FIG. 2, on the assumption that there are a plurality of frequency channels (e.g., 3 channels) that can be assigned to the wireless communication system and on the assumption that the same frequency will not be used between BSs that cover cells adjacent to each other (e.g., BS 100-1 uses channel 1, BS 100-2 uses channel 2, BS 100-3 uses channel 3, and BS 100-4 uses channel 2), then an interference can be prevented relatively easily by parameters such as the wireless output level between BSs and the distance between BSs.

However, if cells are divided for communications by sectoring in a wireless communication system to which it is difficult to assign smaller frequency channels, or if a significant influence is caused by the positional relationship between the BSs and the MSs based on the output level differences between the BSs and the MSs and the output level control thereof, and the radio-wave propagation environment, then there are cases wherein it will be difficult to prevent an interference simply by allocating frequencies.

If there are at most two frequency channels that can be assigned to a wireless communication system and if the same frequency is assigned between BSs and sectors which cover cells adjacent to each other, then it is necessary to perform a frequency reuse control process other than the frequency channel allocation, using the timing to send and receive wireless signals according to a segmenting function, etc., or band division in channels (e.g., division into subchannels in OFDM (Orthogonal Frequency Division Multiplexing) or SOFDMA (Scalable Orthogonal Frequency Division Multiplexing Access).

According to WiMAX, for example, the interference resistance is controlled by changing modulating and demodulating processes from time to time depending on a change in the wireless environment. According to the conventional process, an interference caused by using the same frequency in subchannels for adjacent communication events is dealt with by changing subchannels to be used for a certain communication channel. Therefore, interference seems to be prevented from occurring. However, the signal seems to be experiencing interference as regards the entire band.

If a wireless communication system uses frequency bands that are close to each other or if there is a nearby noise source relevant to the frequency band in use, then the signal tends to suffer interference and an error is liable to continue during a communication session.

With limited wireless resources available for allocation, it is relatively difficult to remove such an externally induced interference. According to the present invention, a solution is provided by introducing an interference measurement to avoid interference as much as possible when the interference occurs, and by indicating the result of the interference measurement from an MS to a BS for a scheduling process for avoiding interference in the next frame.

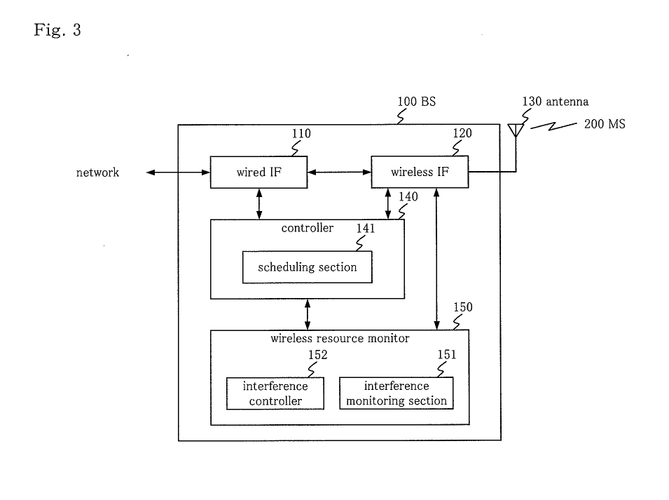

FIG. 3 is a diagram showing an example of the internal configuration of BS 100 shown in FIG. 1.

As shown in FIG. 3, BS 100 shown in FIG. 1 includes wired IF 110, wireless IF 120, antenna 130, wireless resource monitor 150, and controller 140 for controlling these components. FIG. 3 shows only those components according to the present invention, of the components included in BS 100 shown in FIG. 1.

Wired IF 110 has an interfacing function for interfacing with a communication link typified by an ASN (Access Service Network), an Ethernet (registered trademark), or the like as a network.

Wireless IF 120 has a wireless interfacing function for performing wireless communications with MS 200 via antenna 130.

Wireless resource monitor 150 includes interference monitoring section 151 and interface controller 152.

Interference monitoring section 151 monitors an interference situation (reception status) of a wireless signal sent from MS 200 to BS 100.

Interference controller 152 supplies controller 140 with information for controlling resources that can be used based on the result monitored by interference monitoring section 151 and the reception status indicated from MS 200. Specifically, interference controller 152 performs a control process for avoiding interference with a wireless signal between BS 100 and MS 200.

Controller 140 includes a scheduling section 141 for generating frames in a wireless zone between BS 100 and MS 200, and performs a control process for controlling packets while monitoring communication situations from a wireless side and a wired side.

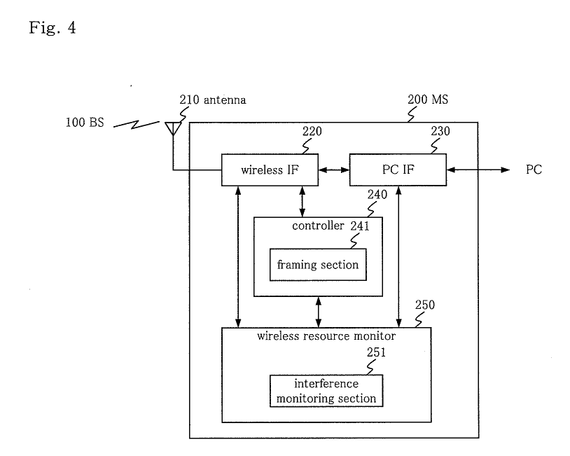

FIG. 4 is a diagram showing an example of the internal configuration of MS 200 shown in FIG. 1.

As shown in FIG. 4, MS 200 shown in FIG. 1 includes antenna 210, wireless IF 220, PC IF 230, wireless resource monitor 250, and controller 240 for controlling these components to control communication timings. FIG. 4 shows only those components according to the present invention, of the components included in MS 200 shown in FIG. 1.

Wireless IF 220 has a wireless interfacing function for performing wireless communications with BS 100 via antenna 210.

PC IF 230 performs an interfacing function for interfacing with a PC or an incorporated CPU using a CardBus PC (Personal Computer) Card, a PCI (Peripheral Component Interconnect), a USB (Universal Serial Bus), a general-purpose input/output interface according to IEEE 1394 or the like, or a dedicated interface.

Wireless resource monitor 250 includes interference monitoring section 251 for monitoring an interference situation (reception status) of a wireless signal sent from BS 100 to MS 200, and monitors wireless resources. Wireless resource monitor 250 indicates the monitored reception status to BS 100 via wireless IF 220 and antenna 210.

Controller 240 includes framing section 241 for analyzing the structure of frames that are generated by BS 100 in a wireless zone.

The present invention is also applicable to CPE (Customer Premises Equipment) which has a wired IF, instead of PC IF 230 of MS 200, and communication means such as an Ethernet (registered trademark).

Antenna 130 shown in FIG. 3 and antenna 210 shown in FIG. 4 may have an MIMO (Multiple Input Multiple Output) structure. In this case, wireless IF 120 and wireless resource monitor 150 shown in FIG. 3 and wireless IF 220 and wireless resource monitor 250 shown in FIG. 4 may be of a packaged form compatible with an MIMO function.

A wireless communication method according to the present exemplary embodiment will be described below.

First, a wireless communication method for general WiMAX will be described below.

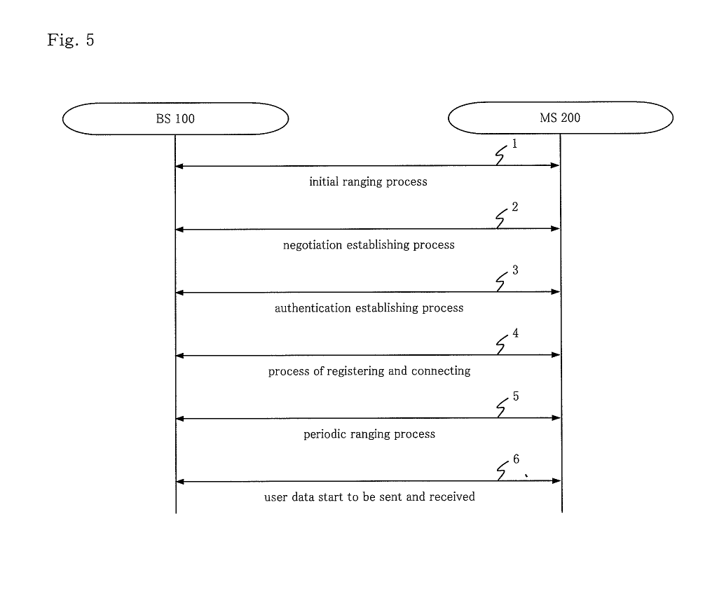

FIG. 5 is a sequence diagram illustrative of a wireless communication method for general WiMAX. It is assumed that a processing sequence to be described below is carried out between BS 100 and MS 200 shown in FIG. 1.

In order for MS 200 to start a communication event with BS 100, downlink channels from a downlink signal sent from BS 100 are scanned and synchronized with frames generated in BS 100. Various parameters are acquired, and an initial ranging process is started between MS 200 and BS 100 in step 1.

In the initial ranging process, MS 200 sends RNG-REQ, which is an initial ranging request, to BS 100. In response to RNG-REQ, BS 100 sends RNG-RSP to MS 200.

If the initial ranging process is successful, then function request information (wireless parameters) is exchanged between MS 200 and BS 100, and a negotiation process is performed in step 2. For example, SBC-REQ, SBC-RSP, etc. are sent and received, as is customary.

Then, an authentication process for MS 200 is performed between BS 100 and MS 200 in step 3. For example, as with a general authentication process, MS 200 sends Auth Request, which is a request for authenticating MS 200, to BS 100, and BS 100 sends Auth Reply, which a reply to Auth Request, to MS 200.

When the authentication in BS 100 of MS 200 is successful, a process of registering and connecting MS 200 to the network is performed in step 4. When the registering and connecting process is successful, MS 200 is connected according to IP (Internet Protocol). The network entry is now completed.

Thereafter, in step 5, a periodic ranging process is performed between BS 100 and MS 200. In step S6, user data start to be sent and received in synchronism with the frame timings scheduled by BS 100.

The wireless communication method according to the present exemplary embodiment will be described below.

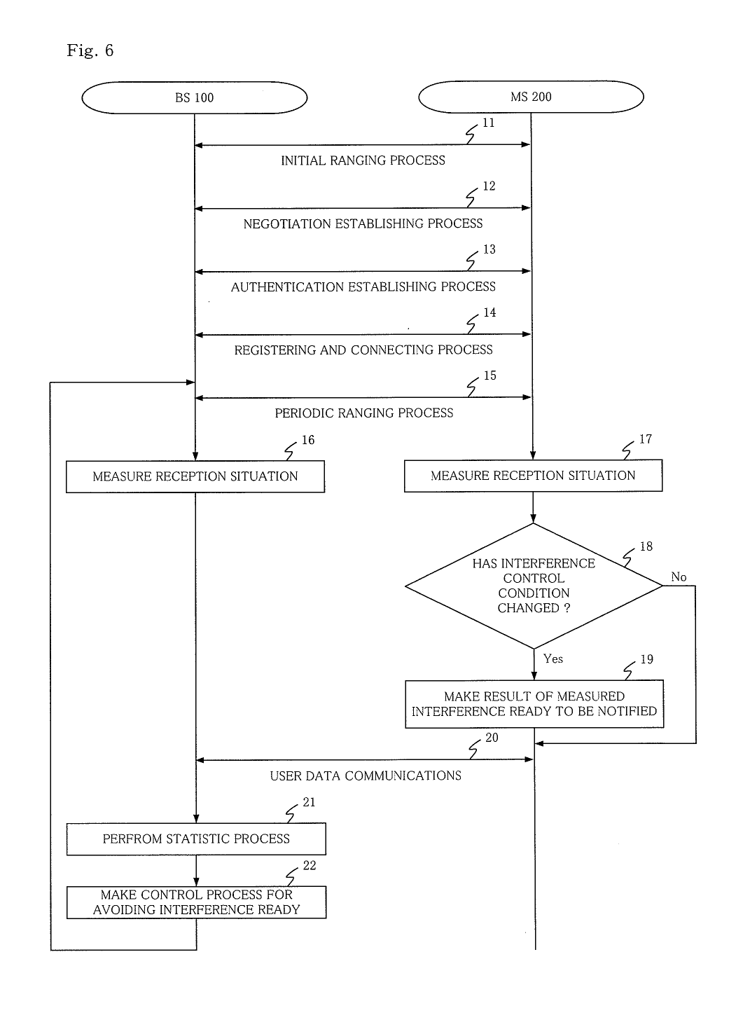

FIG. 6 is a sequence diagram illustrative of the wireless communication method according to the present exemplary embodiment.

A processing sequence from step 11 to step 14 is the same as the processing sequence from step 1 to step 4 described above with reference to FIG. 5.

The present invention resides in a subsequent measurement process for periodic ranging and an interference avoidance control process which uses the measured result from the measurement process.

Upon periodic ranging between MS 200 and BS 100 in step 15, the reception status of an uplink signal sent from MS 20 to BS 100 is measured by interference monitoring section 151 of BS 100 in step 16. The reception status of a downlink signal sent from BS 100 to MS 200 is measured by interference monitoring section 251 of MS 200 in step 17. The reception status primarily represents the signal reception power level, the received signal vs. noise ratio (the ratio of received signal to noise), or the error generation situation (ratio). These values may be measured by general processes.

When the reception status is measured in step 17, interference monitoring section 251 determines in step 18 whether or not an interference control condition has changed based on the measured reception status and the preset interference control condition.

The interference control condition represents a terminal reception power threshold value for the signal reception power level, a terminal SN ratio threshold value for the received signal vs. noise ratio, and a terminal error ratio threshold value for the error regeneration ratio.

For example, if the reception power measured by interference monitoring section 251 is of a value smaller than the terminal reception power threshold value, then it is decided that the interference control condition has changed. If the received signal vs. noise ratio measured by interference monitoring section 251 is of a value smaller than the terminal SN ratio threshold value, then it is decided that the interference control condition has changed. If the error regeneration ratio measured by interference monitoring section 251 is of a value greater than the terminal error ratio threshold value, then it is decided that the interference control condition has changed. A decision may be made based upon determining each of these values, or some of these values may be ANDed to make a decision.

If it is decided that the interference control condition has changed, then the reception status will be combined with the subchannel number used for the communication event, and made ready to be notified as the result of a measured interference result to BS 100 in step 19. Thereafter, in step 20, the interference measurement result including the reception status is included in a frame of the user data used for user data communications, and sent at the indicated timing from wireless IF 220 via antenna 210 to BS 100.

Interference controller 152 of BS 100 performs a statistic process on the reception status indicated from MS 200 and the reception status measured in step 16, in step 21.

At this time, the reception status measured by interference monitoring section 151 in step 16 and the preset interference control condition are compared with each other as if the measurement was undertaken by MS 200. Based on the result of the comparison, it is determined whether or not the interference control condition in BS 100 has changed, and the result of the decision is taken into account.

For example, it is assumed that the interference control condition represents a base station reception power threshold value for the signal reception power level, a base station SN ratio threshold value for the received signal vs. noise ratio, and a base station error ratio threshold value for the error regeneration ratio. If the reception power measured by interference monitoring section 251 in step 16 is of a value smaller than the base station reception power threshold value, then it is decided that the interference control condition has changed. If the received signal vs. noise ratio measured by interference monitoring section 251 is of a value smaller than the base station SN ratio threshold value, then it is decided that the interference control condition has changed. If the error regeneration ratio measured by interference monitoring section 251 is of a value greater than the base station error ratio threshold value, then it is decided that the interference control condition has changed. A decision may be made based upon determining each of these values, or some of these values may be ANDed to make a decision. The reception status is used if the interference control condition has changed as determined by the above decision.

At this time, BS 100 may perform a statistic process based on the reception status s sent from a plurality of MSs. In this case, it is estimated whether or not a subchannel is experiencing interference or whether there is a tendency for a subchannel to experience interference, from the transmission and reception status of a plurality of frames.

In step 22, a control process for avoiding interference with a wireless signal between BS 100 and MS 200 is made ready. Specifically, if the reception status is notified from MS 200 or if interference controller 152 decides that the interference control condition has changed, a control process for avoiding interference with a wireless signal between BS 100 and MS 200 is made ready.

Specifically, the control process for avoiding an interference refers to a process for avoiding the use of the subchannel (the subchannel currently in use) and for using a subchannel other than the subchannel, or, if the subchannel is used because of a lack of communication capacity, for making a subchannel selection with reduced usage priority by changing the modulation process to QPSK1/2 or the like and reflecting the selected subchannel in the scheduling process for each subchannel. Since frequency hopping is performed on subchannels in each frame, a subchannel to which the frequency hopping is directed, is controlled to allow the system to maximally offer the advantages of the present invention.

After MS 200 has performed user data communication, both MS 200 and BS 100 prepare the results of the interference measurement, and BS 100 applies the control process for avoiding interference to the scheduling for the next frame.

The control process for avoiding interference is performed at constant periods or when the interference control condition has changed, and needs to be performed at control intervals that are flexibly capable of coping with an interference environment that changes at all times.

The interference refers to any of various type of interference including an electromagnetic interference such as burst noise from nature, interference from wireless stations of another system which includes fixed stations and movable stations, inter-BS interference, and inter-MS interference within the system. For interference which occurs at all times, a process is performed to lower the priority of selection of the subchannel at all times.

The WiMAX system has been described above by way of example. The present invention is also applicable as generalized embodiments to wireless communication systems other than WiMAX.

It is also possible to consider a system which gives a frequency-like interference, such as a system which applies an OFDM concept to an optical signal that passes through one optical fiber in an optical multiplex system.

An expansion of the method of measuring the interference condition according to the present invention can also be considered.

For example, according to the method described above, the result of interference measured by MS 200 is sent to BS 100 for scheduling. The result of the interference measured by MS 200 may be sent to an interference management server (not shown) added to the network to share the information of the results of the measured interference from the BSs and the MSs, so that the BSs can share information for scheduling via the interference management server.

The above method may be further expanded to share information via the interference management server among a plurality of wireless communication systems which give interferences in near frequency bands or in one frequency band or between a wired communication system and a noise source in a strong electric field, so that the method can be used for scheduling or for physical angle control for communication antennas. According to the present invention, therefore, a nearby base station and a terminal station can always continue to collect results of measured interference in order to dynamically avoid the interference even if their positional relationship changes regardless of moving base stations and terminal stations and fixed base stations and terminal stations.

The present invention is also applicable to a situation wherein when an MS is to select a BS to connect to for network entry from among a plurality of BSs, the BS obtains results of measured interference from the BSs and the interference management server and selects a BS which is less susceptible to interference and which is capable of realizing communications.

If a communication system has a relatively large number of frequency channels, then the results of measured interference may be introduced and used to control channels to be used, or may be reflected in automatically changing channels as a function to automatically re-allocate channels.

As described above, the present invention offers the following advantages:

According to the first advantage, in a situation where interferences around the system change, it is possible for the system to monitor interferences at all times to prevent interference from occurring and to optimize system parameters to maximize the communication capacity as much as possible.

According to the second advantage, it is possible to understand the tendency of interference to occur in individual systems based on the collected results of measured interferences and, in some cases, to reflect the understood tendency in an analysis of station allocations for optimization based on a re-allocation of BSs. Furthermore, it is possible to obtain materials for studying policies for coexisting with other systems and, in some cases, to study efforts to prevent wireless interference itself by adjusting shields and antenna directivity.

As described above, the present invention proposes to increase the efficiency with which frequencies can be used in an interference environment and also to contribute to optimizing power consumption, making it possible in a cellular wireless communication system such as a mobile WiMAX system to avoid communication interference between itself and an adjacent system and also between base stations and terminal stations even in an environment where it is relatively difficult to reuse frequencies due to the reduced number of assigned frequency channels.

The processing sequences performed by the components of BS 100 and MS 200 may be implemented by logic circuits that have manufactured according to the respective purposes for which they are to be used. Alternatively, programs which describe of the processing sequences may be recorded on a recording medium that can be read by BS 100 and MS 200, and may be read and executed by BS 100 and MS 200. The recording medium which can be read by BS 100 and MS 200 may refer to a removable recording medium such as a floppy disk (registered trademark), a magnetooptical disk, a DVD, a CD, or the like, or a memory such as a ROM, a RAM, or the like or an HDD or the like incorporated in BS 100 and MS 200. The programs recorded in the recording medium are read by a CPU (not shown) in BS 100 and MS 200, and the CPU performs a control sequence to carry out the same processes as described above. The CPU operates as a computer for executing the programs read from the recording medium on which the programs are recorded.

The present invention has been described above in reference to the exemplary embodiment. However, the present invention is not limited to the above exemplary embodiment. Rather, various changes that can be understood by those skilled in the art within the scope of the invention may be made to the form and details of the present invention.

The present application is based upon and claims the benefit of priority from Japanese patent application No. 2009-190800, filed on Aug. 20, 2009, the disclosure of which is incorporated herein in its entirety by reference.

1. A wireless communication system comprising a wireless base station and a wireless communication terminal, wherein
said wireless communication terminal measures a reception status of a downlink signal sent from said wireless base station according to a periodic ranging process, and notifies the measured reception status of the downlink signal to said wireless base station; and
said wireless base station measures a reception status of an uplink signal sent from said wireless communication terminal according to the periodic ranging process, and performs a control process for avoiding interference with a wireless signal between said wireless base station and said wireless communication terminal based on the measured reception status of the uplink signal and the measured reception status of the downlink signal which is notified from said wireless communication terminal.

2. The wireless communication system according to claim 1, wherein said wireless communication terminal measures a received signal vs. noise ratio of said downlink signal as the reception status, and, if the measured received signal vs. noise ratio is of a value smaller than a preset terminal SN ratio threshold value, notifies the received signal vs. noise ratio to said wireless base station; and
said wireless base station measures a received signal vs. noise ratio of said uplink signal as the reception status, and, if the measured received signal vs. noise ratio is of a value smaller than a preset base station SN ratio threshold value, or if the received signal vs. noise ratio is notified from said wireless communication terminal, performs the control process for avoiding interference with a wireless signal between said wireless base station and said wireless communication terminal based on the received signal vs. noise ratio notified from said wireless communication terminal and the received signal vs. noise ratio of said uplink signal which is of the value smaller than the preset base station SN ratio threshold value.

3. The wireless communication system according to claim 1, wherein said wireless communication terminal measures an error generation ratio of said downlink signal as the reception status, and, if the measured error generation ratio is of a value greater than a preset terminal error ratio threshold value, notifies the error generation ratio to said wireless base station; and
said wireless base station measures an error generation ratio of said uplink signal as the reception status, and, if the measured error generation ratio is of a value greater than a preset base station error ratio threshold value, or if the error generation ratio is notified from said wireless communication terminal, performs the control process for avoiding an interference with a wireless signal between said wireless base station and said wireless communication terminal based on the error generation ratio notified from said wireless communication terminal and the error generation ratio of said uplink signal which is of the value greater than the preset base station error ratio threshold value.

4. The wireless communication system according to claim 1, wherein said wireless communication terminal measures a reception power level of said downlink signal as the reception status, and, if the measured reception power level is of a value smaller than a preset terminal reception power threshold value, notifies the reception power level to said wireless base station; and
said wireless base station measures a reception power level of said uplink signal as the reception status, and, if the measured reception power level is of a value smaller than a preset base station reception power threshold value, or if the reception power level is notified from said wireless communication terminal, performs the control process for avoiding an interference with a wireless signal between said wireless base station and said wireless communication terminal based on the reception power level notified from said wireless communication terminal and the reception power level of said uplink signal which is of the value smaller than the preset base station reception power threshold value.

5. The wireless communication system according to claim 1, wherein said wireless base station avoids interference by communicating with said wireless communication terminal using a subchannel other than a subchannel which is currently in use.

6. The wireless communication system according to claim 1, wherein said wireless base station avoids interference by lowering the priority of selection of a subchannel by changing a modulating process.

7. The wireless communication system according to claim 1, wherein said wireless communication terminal notifies the measured reception status of the downlink signal to said wireless base station at a timing notified from said wireless base station.

8. The wireless communication system according to claim 1, for use as a WiMAX (Worldwide Interoperability for Microwave Access) system.

9. A wireless base station for performing wireless communications with a wireless communication terminal, comprising:
an interference monitoring section which measures a reception status of an uplink signal sent from said wireless communication terminal according to a periodic ranging process; and
an interference controller which performs a control process for avoiding interference with a wireless signal between said wireless base station and said wireless communication terminal based on the reception status of the uplink signal measured by said interference monitoring section and a reception status of a downlink signal in the periodic ranging process which is notified from said wireless communication terminal.

10. A method of performing wireless communications between a wireless base station and a wireless communication terminal, comprising the steps of:
measuring a reception status of a downlink signal sent from said wireless base station to said wireless communication terminal according to a periodic ranging process;
measuring a reception status of an uplink signal sent from said wireless communication terminal to said wireless base station according to the periodic ranging process; and
performing a control process for avoiding an interference with a wireless signal between said wireless base station and said wireless communication terminal based on the reception status of the uplink signal and the reception status of the downlink signal.

11. The method of performing wireless communications according to claim 10, wherein:
the step of measuring the reception status of the downlink signal involves measuring a received signal vs. noise ratio of said downlink signal as the reception status;
the step of measuring the reception status of an uplink signal involves measuring a received signal vs. noise ratio of said uplink signal as the reception status; and
the step of performing the control process involves performing the control process if the received signal vs. noise ratio of said downlink signal is of a value smaller than a preset terminal SN ratio threshold value or if the received signal vs. noise ratio of said uplink signal is of a value smaller than a preset base station SN ratio threshold value.

12. The method of performing wireless communications according to claim 10, wherein:
the step of measuring the reception status of the downlink signal involves measuring an error generation ratio of said downlink signal as the reception status;
the step of measuring the reception status of the uplink signal involves measuring an error generation ratio of said uplink signal as the reception status; and
the step of performing the control process involves performing the control process if the error generation ratio of said downlink signal is of a value greater than a preset terminal error ratio threshold value or if the error generation ratio of said uplink signal is of a value greater than a preset base station error ratio threshold value.

13. The method of performing wireless communications according to claim 10, wherein:
the step of measuring the reception status of the downlink signal involves measuring a reception power level of said downlink signal as the reception status;
the step of measuring the reception status of the uplink signal involves measuring a reception power level of said uplink signal as the reception status; and
the step of performing the control process involves performing the control process if the reception power level of said downlink signal is of a value smaller than a preset terminal reception power threshold value or if the reception power level of said uplink signal is of a value smaller than a preset base station reception power threshold value.

14. (canceled)
